(19) United States
(12) Patent Application Publication
(10) Pub. No.: US 2026/0244182 A1
(43) Pub. Date: Aug. 20, 2026

(54) Control System and Method

(71) Applicant: Hitachi Industrial Equipment Systems Co., Ltd., Chiyoda-ku, Tokyo (JP)

(72) Inventors: Toru YAZAKI, Tokyo (JP); Hironori WAKANA, Tokyo (JP); Masayoshi OJIMA, Tokyo (JP); Masahiro YAMAZAKI, Tokyo (JP); Kenji SHIMODA, Tokyo (JP); Masayoshi SUDOH, Tokyo (JP); Yuki MAENO, Tokyo (JP); Mitsuru SOGA, Tokyo (JP)

(21) Appl. No.: 18/995,284

(22) PCT Filed: May 31, 2023
(86) PCT No.: PCT/JP2023/020367

§ 371 Date: Jan. 16, 2025

(30) Foreign Application Priority Data
Jul. 29, 2022 (JP) 2022-122331

(51) Int. Cl. G05B 19/05

(52) U.S. Cl. CPC G05B 19/056

(57) ABSTRACT

A control system including a control program and an information program includes a management program, and a parameter set for the information program. The control program is a program that performs a scanning process (a process that controls a control object apparatus and has real-time characteristics) within a control cycle. The control program transmits, within the control cycle, a control instruction that is a signal representing a symbol associated with an activation object information program. The management program receives the control instruction, identifies the activation object information program corresponding to the symbol represented by the received control instruction, reads the parameter set for the activation object information program, generates an activation signal associated with the read parameter set, and outputs the generated activation signal to the activation object information program.

### TECHNICAL FIELD

The present invention generally relates to a control technology.

### BACKGROUND ART

For example, a control system disclosed in Patent Literature 1 has been known. The control system includes a control apparatus. In the control apparatus, a control program and an information program are executed.

### CITATION LIST

### Patent Literature

Patent Literature 1: Japanese Patent Laid-Open No. 2018-84994

### SUMMARY OF INVENTION

### Technical Problem

In a control system, a control apparatus may be an industrial control apparatus, and a control object apparatus of the control apparatus may be, for example, any of industrial apparatuses, such as an industrial motor and a compressor. A control program in the control apparatus controls such a control object apparatus. Specifically, for example, the control program performs a scanning process that is a process for controlling a control object apparatus and is a process having real-time characteristics, at each control cycle defined for the control program, within the control cycle. The information program performs information processing defined for the information program.

The control apparatus may be called a sequence control apparatus, a motion control apparatus, or a programmable logic controller (PLC). Typically, the control program in the control apparatus has control content described in a control-specific programming language, such as a ladder logic (LD language), a sequential function chart (SFC language), a function block (FBD language), a structured text (ST language), or an instruction list (IL language).

The control program can be described that operates at least one information program among one or multiple information programs within a control cycle.

However, operating the information program requires generating an activation signal for the information program and outputting the activation signal to the information program. It is typically required that a parameter set (one or more parameters) used by an activation object information program is associated with the output activation signal, and the control program reads the parameter set for the activation signal. Because of these reasons, the amount of scan process increases. Consequently, the control cycle is elongated, and the amount of description of the control program increases.

### Solution to Problem

A control system that controls one or multiple control object apparatuses includes one or multiple computation apparatuses. The one or multiple computation apparatuses include a control program, one or multiple information programs, a management program, and a parameter set for each of the one or multiple information programs. The parameter set is one or more parameters required for the information program, with respect to each of the one or multiple information programs. The control program is a program that performs a scanning process that is a process for controlling the control object apparatus and is a process having real-time characteristics, at each control cycle defined for the control program, within the control cycle. With respect to each of the one or multiple information programs, the information program is a program that performs information processing defined for the information program. The control program transmits, within the control cycle, a control instruction that is a signal representing a symbol associated with an activation object information program among the one or multiple information programs. The management program receives the control instruction, and identifies the activation object information program corresponding to the symbol represented by the received control instruction. The management program reads the parameter set for the activation object information program, generates an activation signal associated with the read parameter set, and outputs the generated activation signal to the activation object information program.

### Advantageous Effect of Invention

According to the present invention, even if operation of the information program is required in the control cycle, the amount of scan process of the control program can be prevented from increasing.

### BRIEF DESCRIPTION OF DRAWINGS

FIG. 1 shows an example of a physical configuration of a system that includes a control system according to a first embodiment.

FIG. 2 shows an example of a logic configuration of the control system according to the first embodiment.

FIG. 3 shows an example of a logic configuration of a control system according to a second embodiment.

FIG. 4 shows an example of a logic configuration of a control system according to a third embodiment.

### DESCRIPTION OF EMBODIMENTS

In the following description, “interface apparatus” may be one or more interface devices. The one or more interface devices may be at least one of the following.

I/O interface apparatuses that are one or more I/O (Input/Output) interface devices. The I/O interface device is an interface device for at least one of an I/O device and a remote display computational machine. The I/O interface device for the display computational machine may be a communication interface device. At least one I/O device may be any of user interface devices, for example, an input device, such as a keyboard and a pointing device, and an output device, such as a display device.
Communication interface apparatuses that are one or more communication interface devices. The one or more communication interface devices may be one or more communication interface devices of the same type (e.g., one or more NICs (Network Interface Cards) ), or two or more communication interface devices of different types (e. g., an NIC and an HBA (Host Bus Adapter) ).

In the following description, “memory” may be one or more memory devices, and typically, a main memory device. At least one memory device in the memory may be a volatile memory device, or a nonvolatile memory device.

In the following description, “persistent storage apparatus” is one or more persistent storage device. The persistent storage device is, typically, a nonvolatile storage device (e.g. an auxiliary storage device), and specifically, for example, an HDD (Hard Disk Drive) or an SSD (Solid State Drive).

In the following description, “storage apparatus” may be at least the memory between the memory and the persistent storage apparatus.

In the following description, “processor” may be one or more processor modules. At least one processor module is, typically, a microprocessor device, such as a CPU (Central Processing Unit), but may be another type of processor device, such as a GPU (Graphics Processing Unit). At least one processor device may be a single-core one or a multi-core one. At least one processor module may be a processor core.

In the following description, processing is sometimes described using the program as a subject. However, the program is executed by a processor to thereby perform a predefined process as appropriate using the storage apparatus, interface apparatus, and/or the like. Accordingly, the subject of the processing may be the processor (or a device, such as a controller that includes the processor). The program may be installed in an apparatus, such as a computational machine, from a program source. The program source may be, for example, a (for example, non-transitory) recording medium that can be read by a program distribution server or a computational machine. In the following description, two or more programs may be implemented as one program, and one program may be implemented as two or more programs.

In the following description, there are cases where processing is described using a function (e.g. a function represented as a “yyy” unit) as a subject. The function may be implemented by one or more computer programs being executed by a processor. When the functions are implemented by the program being executed by the processor, since predetermined processing is performed using the storage apparatus, the interface apparatus, and/or the like as appropriate, the functions may be regarded as at least part of the processor. Processing described by using the functions as a subject may be made processing which the processor or an apparatus including the processor performs. Description of each function is an example, and a plurality of functions may be integrated into one function, or one function may be divided into a plurality of functions.

In the following description, when elements of the same type are described without any discrimination, common parts of reference symbols are used, and when elements of the same type are described in a manner of being discriminated from each other, reference symbols are sometimes used.

### First Embodiment

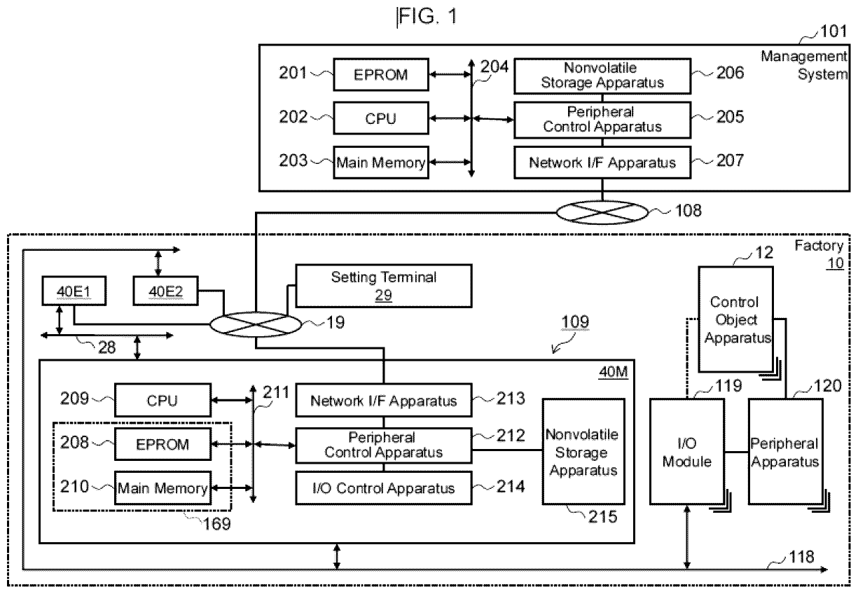

FIG. 1 shows an example of a physical configuration of a system that includes a control system according to a first embodiment.

The control system 109 is installed in a factory 10 where control object apparatuses 12 reside. The control object apparatuses 12 are, for example, industrial apparatuses, such as an industrial motor and a compressor. The factory 10 is an example of a site where the control object apparatuses 12 reside.

The management system 101 and the control system 109 are coupled to a communication network 108 (e.g. the Internet or a WAN (Wide Area Network) ). The control system 109 is coupled to, for example, a communication network 19 (e.g. an LAN (Local Area Network) ) in the factory 10. The control system 109 can communicate with the management system 101 via the communication networks 19 and 108. The communication networks 108 and 19 are communication networks used for an information communication process (a communication process different from a process of transmitting control data to the control object apparatuses 12 in a scanning process by the control program) performed by an information program.

The control system 109 and one or more I/O modules 119 (an example of an I/O port) are coupled to a communication network 118 (e.g. Ethernet (R)). The communication network 118 is a communication network used to transmit control data to the control object apparatuses 12 in a control process that the control program performs.

The communication networks 19, 108, and 118 may be networks different from each other. Two or more communication networks among the communication networks 19, 108, and 118 may be the same networks.

One or more peripheral appliances 120 are coupled to the one or more I/O modules 119. The peripheral appliances 120 may be apparatuses, such as sensors and media drives (e.g., an HDD or an SSD). The I/O modules 119 function as bus slots to which the peripheral appliances 120 are detachably attached as needed. The control object apparatuses 12 are coupled to the I/O modules 119 through or not through the peripheral appliances 120. The control object apparatuses 12 and the I/O modules 119 may be any of 1:1, 1: many, many: 1, and many: many. Some I/O modules 119 may be coupled not only to the communication network 118 but also to the communication network 108. That is, these I/O modules 119 may be devices shared among the control program and the information programs. At least one I/O module 119 may be at least part of the network I/F apparatus and an I/O control apparatus of at least one computation apparatus 40.

The management system 101 is an example of a higher-level system of the control system 109. The management system 101 includes an EPROM 201, a CPU 202, a main memory 203, a peripheral control apparatus 205, a nonvolatile storage apparatus 206, and a network I/F apparatus 207. The management system 101 is coupled to the communication network 108 via the network I/F apparatus 207.

The control system 109 includes one or multiple computation apparatuses 40. Each computation apparatus 40 includes an interface apparatus, a storage apparatus, and a processor coupled to them. All the computation apparatuses 40 may have hardware configurations that are identical to or different from each other. Each of the computation apparatuses 40 may be an installation destination of the control program, or an installation destination of the information program. In the present embodiment, a computation apparatus 40M is a main computation apparatus, and a computation apparatus that is an installation destination of the control program and can be an installation destination of the information program. Each of the computation apparatuses 40E1 and 40E2 is an expanded computation apparatus, and is a computation apparatus that cannot be an installation destination of the control program and can be an installation destination of the information program. The computation apparatuses 40E may be omitted. In other worlds, the computation apparatus 40M may solely constitute the control system 109. Hereinafter, the computation apparatus 40M is called “control apparatus 40M”, and the computation apparatus 40E is called “extension apparatus 40E”, in some cases.

The system configuration of the control system 109 varies depending on whether the extension apparatus 40E is present, which type of communication media to which the extension apparatus 40E is coupled is, and which computation apparatus 40 the information program communicating with the control program is disposed in.

That is, the system configuration depends on presence or absence of the extension apparatus 40E, the type of communication media to which each of the control apparatus 40M and the extension apparatus 40E is coupled, and the computation apparatus 40 that is the installation destination of each application. In the example in FIG. 1, the extension apparatus 40E1 is coupled to the communication network 118. The extension apparatus 40E2 is coupled to a PIO bus 28 (an example of a bus) (“PIO”is an abbreviation for Programmed I/O) . The PIO bus 28 may be a bus printed on a base board. The control apparatus 40M and the extension apparatus 40E2 are coupled to the base board, which may allow the control program executed by the control apparatus 40M, and the information program executed by the extension apparatus 40E2 to transmit (share) data via the PIO bus 28.

Using the control apparatus 40M as an example, the hardware configuration of the computation apparatuses 40 is described as follows, for instance. That is, the control apparatus 40M includes a memory 169 (e.g., an EPROM 208 and a main memory 210), a peripheral control apparatus 212, an I/O control apparatus 214, a nonvolatile storage apparatus 215, a network I/F apparatus 213, and a CPU 209 coupled to them. The I/O control apparatus 214 and the network I/F apparatus 213 are examples of the interface apparatuses. The memory 169 and the nonvolatile storage apparatus 215 are examples of the storage apparatuses. The CPU 209 is an example of the processor.

The peripheral control apparatus 212 is coupled to the network I/F apparatus 213, the I/O control apparatus 214, the nonvolatile storage apparatus 215, and a bus 211. Furthermore, the memory 169 and the CPU 209 are coupled to the bus 211. The apparatuses 213, 215, and 214 are controlled via the peripheral control apparatus 212.

The EPROM 208 may preliminarily store the control program, and at least one of the information programs, or store programs downloaded from a program source, such as a program distribution server (not shown). Each of the numbers of control programs and information programs installed in the control system 109 is not necessarily one. Alternatively, a plurality of control programs and/or a plurality of information programs can be installed by setting resources usable by the control system 109, with respect to each program.

The CPU 209 reads the control program (and the information programs) stored in the EPROM 208 into the main memory 210, and executes the program, and controls the operation of the control program (and the information programs). For example, the CPU 209 executes the control program, thereby controlling the peripheral appliances 120 via the peripheral control apparatus 212, the I/O control apparatus 214, and the I/O modules 119. The peripheral appliances 120 may be associated with I/O modules 119 in 1:1 correspondence. The CPU 209 may be a single-core one or a multi-core one. One core may execute at least one application among the one or more control programs and the one or more information programs. Typically, one core may execute one control program, one control program and one or more information programs, or one or more information programs.

The setting terminal 29 is coupled to the control system 109 (e.g. the control apparatus 40M) via the communication network 19 (or without intervention of the communication network 19). The setting terminal 29 is, for example, a computational machine that includes an input device, a display device, an interface apparatus, a storage apparatus, and a processor coupled to them (e.g., a desktop type, laptop type, or tablet type personal computer, or a smartphone). The setting terminal 29 may issue an instruction and perform setting for the control system 109. The setting terminal 29 may be part of the management system 101.

As described above, each computation apparatus 40 includes the interface apparatus, the storage apparatus, and the processor coupled to them. The control apparatus 40M is an example of a first computation apparatus. The extension apparatus 40E is an example of a second computation apparatus. The interface apparatus of the control apparatus 40M, and the interface apparatus of the extension apparatus 40E are communicably coupled to each other. Through these interface apparatuses, signals are transmitted and received.

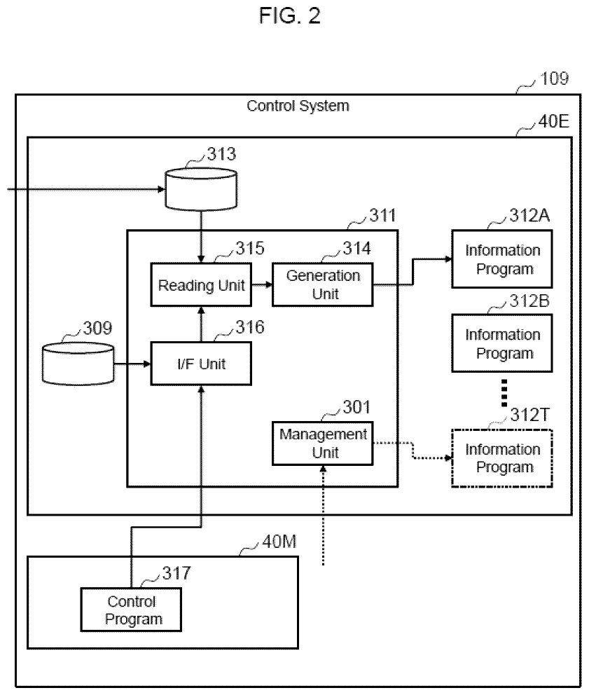

FIG. 2 shows an example of a logic configuration of the control system 109.

The control program 317 is executed by the CPU of the control apparatus 40M. The control apparatus 40M may be called a sequence control apparatus, a motion control apparatus, or a programmable logic controller (PLC). Typically, a control program 317 has control content described in a control-specific programming language, such as a ladder logic (LD language), a sequential function chart (SFC language), a function block (FBD language), a structured text (ST language), or an instruction list (IL language). The control program 317 may be, for example, a program that performs sequence control. The control program 317 is a program that performs a scanning process that is a process for controlling the control object apparatus 12 and is a process having real-time characteristics, at each control cycle defined for the control program 317, within the control cycle.

The information program 312 is executed by the CPU of the extension apparatus 40E. The information program 312 performs information processing defined for the information program 312. The information program 312 is activated by an activation signal (call signal), and operates (executes predetermined information processing). The extension apparatus 40E includes a plurality of (or one) information programs 312.

If the activation object information program 312 is present in the control cycle, the control program 317 in the control system 109 is required to output a signal that designates this information program 312. There is, however, no need to read a parameter set required for the information program 312, and to generate the activation signal (the activation signal of the information program 312) associated with the parameter set. Accordingly, even if operation of the information program 312 is required in the control cycle, the amount of scan process of the control program 317 can be prevented from increasing.

Specifically, the control program 317 is configured to transmit, within the control cycle, a control instruction that designates a symbol associated with the activation object information program 312 among the plurality (or one) information programs 312. For example, the control program 317 transmits a control signal designating a symbol “100” if the information program 312A is the activation object information program, and transmits a control signal designating a symbol “101” if the information program 312B is the activation object information program. The control program 317 may identify the symbol of the activation object information program with reference to a table, not shown. Alternatively, the symbol for each information program may be described in the control program 317.

It is configured such that the information program 312 is not executed by the control apparatus 40M that executes the control program 317, but is executed by the extension apparatus 40E that does not execute the control program 317. The extension apparatus 40E includes a management program 311. The management program 311: (a) receives the control instruction from the control program 317; (b) identifies the information program 312 corresponding to the symbol associated with the received control instruction; (c) reads the parameter set for the identified information program 312; (d) generates an activation signal associated with the read parameter set; and (e) outputs the generated activation signal to the information program 312 identified in (b).

The information program 312 may be made up of an application program, and a container of the application program (an example of an execution environment). The activation signal of the information program 312 may be a signal for activating the container associated with the parameter set, and the management program 311 may be a program (e.g. a script) for activating the container.

Since the management program 311 activates the container, it is expected to negate the need of the following, for example.
A user-defined dedicated network is preliminarily created.
A container port is published at the IP address of the container host.
The control program 317 transmits not only the parameter set for the information program 312 but also the container port number.

The management program 311 has functions, such as an I/F unit (interface unit) 316, a reading unit 315, a generation unit 314, and a management unit 301.

The I/F unit 316 receives the control instruction from the control program 317, and identifies the information program 312 corresponding to the symbol associated with the received control instruction, based on a lookup table 309. The lookup table 309 is stored in the storage apparatus (the memory 169 or the nonvolatile storage apparatus 215) of the extension apparatus 40E.

The lookup table 309 represents the symbol, and the ID (identification data) of the information program 312 corresponding to the symbol, with respect to each information program 312 that can be activated (i.e., each symbol that can be associated with the control instruction). The ID of the information program 312 may be data that is an element of the generated activation signal (e.g. the name of the information program 312), or data as a key used to identify the parameter set that is to be read, from the parameter set group 313. Note that the management program 311 may identify the information program 312 corresponding to the symbol associated with the control instruction, according to a method different from the method using the lookup table 309 (for example, a value obtained by the management program 311 performing predetermined computation using the symbol may serve as the ID of the information program 312). The “symbol” of the information program 312 may be a control instruction (signal) transmitted from the control program 317. The “ID” of the information program 312 may be the name of the information program 312. For example, it is assumed that the symbol is “0x0100”, the information program 312 corresponding to this symbol is the information program 312A, and the ID (name) is “Info. A”. When the management program 311 receives the control instruction (symbol) representing the symbol “0x0100”, the ID “Info. A” corresponding to the symbol “0x0100” is identified from the lookup table 309, the identified ID “Info. A” and the parameter set acquired for the information program 312A are included in the activation signal of the information program 312A.

The reading unit 315 reads the parameter set corresponding to the ID of the identified information program 312, from the parameter set group 313. The parameter set is one or more parameters. The parameter set group 313 may be one or more parameter sets, and for example, a setting file for each information program 312. The parameter set may be described in the setting file. To identify the setting file, the ID of the identified information program 312 may be used as a key. The parameter set group 313 is stored in the storage apparatus of the extension apparatus 40E, through or not through the management program 311 (e.g. the management unit 301).

The generation unit 314 generates the activation signal associated with the read parameter set. To generate the activation signal, the ID of the identified information program 312 may be used. The generation unit 314 outputs the generated activation signal to the identified information program 312. In the example shown in FIG. 2, the identified information program is the information program 312A. Accordingly, the activation signal is output to the information program 312A. In response to the activation signal, the information program 312A is activated, and operates. In this operation, information processing described in the information program 312 is executed.

The management unit 301 is not necessarily required. The management unit 301 may install, uninstall, and update the information program 312. For example, the following may be performed by the management unit 301. Note that the source of the information program 312 may be any apparatus, and may be, for example, a portable storage medium, the management system 101 (e.g. a server) shown in FIG. 1, or the control apparatus 40M.
The management unit 301 accepts an installation instruction for the additional activation object information program 312T into the extension apparatus 40E. In response to the instruction, the management unit 301 installs the information program 312T into the extension apparatus 40E. As the information program 312T is added, the management unit 301 accepts the parameter set for the information program 312T, and adds the parameter set to the parameter set group 313. As the information program 312T is added, the management unit 301 accepts the symbol and ID of the information program 312T, and adds the symbol and the ID to the lookup table 309.
The management unit 301 accepts an update instruction for the information program 312T. In response to the instruction, the management unit 301 updates the information program 312T. If the configuration of the parameter set is changed according to this update, the management unit 301 also updates the parameter set corresponding to the information program 312T in the parameter set group 313 (for example, the parameter set is replaced).
The management unit 301 accepts an uninstallation instruction for the removal activation object information program 312T, into the extension apparatus 40E. In response to the instruction, the management unit 301 uninstalls the information program 312T from the extension apparatus 40E. As the information program 312T is removed, the management unit 301 removes the parameter set for the information program 312T from the parameter set group 313. As the information program 312T is removed, the management unit 301 may remove the symbol and the ID of the information program 312T from the lookup table 309.

As described above, the information program 312 can be added and removed. In the present embodiment, even if the information program 312 is added, updated, or removed, the control program 317 is not substantially required to be changed. Accordingly, the function of the control system 109 can be easily extended and changed.

The control program 317 and the information programs 312 may be executed on the same platform (the same CPU (and memory)), such as the control apparatus 40M. However, in the present embodiment, the information program 312 is executed on the extension apparatus 40E (another platform), which is a computation apparatus different from the control apparatus 40M (the platform of the control program 317). The management program 311 is executed on the same apparatus (including the information program 312) as the apparatus that executes the information programs 312. In the present embodiment, the information programs 312 are executed by the extension apparatus 40E. Accordingly, the management program 311 is also executed by the extension apparatus 40E.

Accordingly, the limitation on the control apparatus 40M is reduced. Consequently, the apparatuses can be easily replaced in the control system 109. It is expected that a greater amount of resources usable by the control program 317 can be reserved.

### Second Embodiment

A second embodiment is described. In this case, the difference from the first embodiment is mainly described, and description of points common to those in the first embodiment is omitted or simplified.

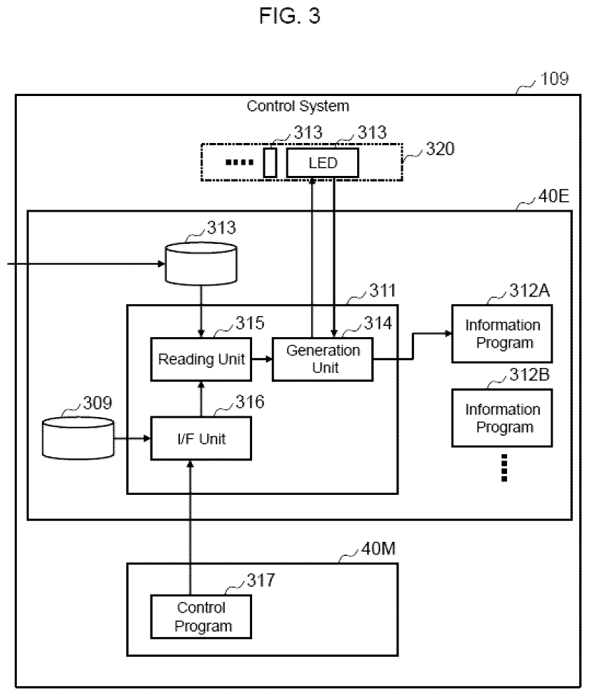

FIG. 3 shows an example of a logic configuration of a control system according to the second embodiment.

An output apparatus 320 is coupled to at least one computation apparatus 40 among the plurality of (or one) computation apparatuses 40. The output apparatus 320 may be a display apparatus (e.g. a liquid crystal display).

However, in the present embodiment, this apparatus is one or more LEDs (Light Emitting Diodes) 313. The LEDs 313 may correspond to the information programs 312. For example, LEDs with one or more colors may be provided for each information program 312.

The generation unit 314 of the management program 311 causes the output apparatus 320 to perform output for notification about at least one of the following.
(a) Whether any of the information programs 312 is in operation.
(b) Which information program 312 is activated.
(c) Whether the activated information program is in normal operation.

For example, (a) may be that at least one of the LEDs 313 is turned on. (b) may be that the LED 313 corresponding to the activated information program 312 is turned on. (c) may be that the LED 313 with a first color is turned on when the activated information program 312 is in normal operation, and the LED 313 with a second color is turned on when the activated information program 312 is abnormal.

Accordingly, the user can be notified of the state of each information program 312 in the control system 109. In a case or the like in which the extension apparatus 40E has frozen and does not operate, the user can easily know such a state.

### Third Embodiment

A third embodiment is described. In this case, the difference from the first and second embodiments is mainly described, and description of points common to those in the first and second embodiments is omitted or simplified.

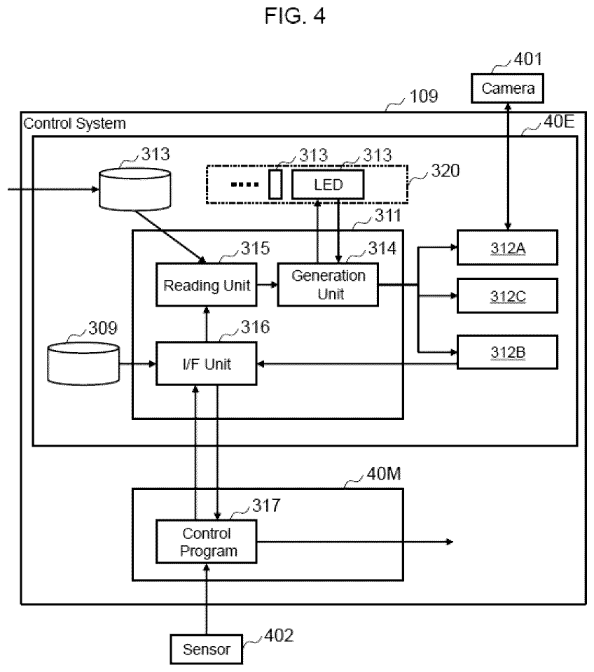

FIG. 4 shows an example of a logic configuration of a control system according to the third embodiment.

The I/F unit 316 of the management program 311 accepts the processing result of the activated information program 312B from this information program 312B, and notifies the control program 317 of the processing result. The control program 317 notified of the processing result controls the control object apparatus 12 depending on the processing result. As described above, the processing result of the information program 312 can be transmitted to the control program 317 via the management program 311. Accordingly, based on this processing result, control can be performed by the control program 317.

When besides the control program 317 the information program is in the control apparatus 40M, the notification destination of the processing result may be the control program 317, or the information program in the control apparatus 40M instead of the control program 317. When the information program in the control apparatus 40M receives the processing result, the control program 317 may receive the processing result via a shared memory of the control apparatus 40M (a shared memory that stores information exchanged between the control program 317 and the information program) (or via another medium). Based on the display form of the LEDs 313, the user can determine whether the operation of each information program and the other operation are normal.

Note that in FIG. 4, the control system 109 is configured to inspect an inspection object, and the extension apparatus 40E functions as an inspection apparatus. Various objects or services can be adopted as “inspection objects”, and data of the “inspection objects” are, for example, image data, sensor data (e.g., vibration data or current data), or sound data. In the present embodiment, the inspection objects are products as examples of objects, and “data of inspection objects” is image data of products, in particular, image data of the appearances of products. Accordingly, the inspection apparatus is an appearance inspection apparatus. There are a camera 401 and a sensor 402. The camera 401 takes images of a product. The sensor 402 inspects the product flowing on a conveyor and passing through a predetermined position.

That is, for example, the information program 312A is a program that causes the camera 401 to take an image, the information program 312C is a program for training a machine learning model for inspection (e.g. a neural network as an example of a deep learning model), and the information program 312B is a program for making an inference using a trained machine learning model (i.e., an appearance inspection of a product). On the lookup table 309, “100” is recorded as a symbol corresponding to the information program 312B, “101” is recorded as a symbol corresponding to the information program 312C, and “102” is recorded as a symbol corresponding to the information program 312A. For example, in the parameter set group 313, the parameter set for the information program 312C (the program for executing learning) may include the number of learning images, the ID of the machine learning model, and the number of epochs. In the present embodiment, the following control can be performed.

Before the appearance inspection is started, the control program 317 transmits a control instruction associated with the symbol “101”, to the management program 311. The management program 311 identifies the information program 312C corresponding to the symbol “101”, and reads the parameter set for the information program 312. The management program 311 generates an activation signal (an activation signal for the information program 312C) associated with the parameter set, and outputs the activation signal to the information program 312C, thereby activating the information program 312C. The activated information program 312C serves as a learning unit, and trains the machine learning model using at least some parameters of the parameter set associated with the activation signal.

After learning, control is performed in each control cycle. That is, in each control cycle, the following (x) and (y) are performed.

(x) When a product is detected by the sensor 402, the control program 317 transmits the control instruction associated with the symbol “102”, to the management program 311. The management program 311 identifies the information program 312A corresponding to the symbol “102”, reads the parameter set for the information program 312A, and generates and outputs the activation signal (the activation signal for the information program 312A) associated with the parameter set. Accordingly, the information program 312A causes the camera 401 to take an image of the product, and acquires captured image data of the product.

(y) Next, the control program 317 transmits the control instruction associated with the symbol “100”, to the management program 311. The management program 311 identifies the information program 312B corresponding to the symbol “100”, reads the parameter set for the information program 312B, and generates and outputs the activation signal (the activation signal for the information program 312B) associated with the parameter set. Consequently, the information program 312B uses the trained machine learning model, and performs an appearance inspection of the product represented by the image data acquired in (x). The information program 312B returns the result of the appearance inspection to the management program 311, and the management program 311 transmits the result to the control program 317. If the result is a result indicating abnormality (i.e., the product is an abnormal one), the control program 317 causes an excluding apparatus (an example of a control object apparatus) for excluding a product from a conveyor to exclude the product from the conveyor.

Although some embodiments are described above, these are examples for describing the present invention. There is no intention to limit the scope of the present invention only to these embodiments. The present invention can be implemented in other various forms. For example, in the third embodiment, in inference after learning, the program for inference may also have an imaging function, and allow imaging and inference to be executed at the same time. The program for inference may be an example of the information program, or a program that is not classified as an information program.

### REFERENCE SIGN LIST

109 Control system

1. A control system that controls one or multiple control object apparatuses, the control system comprising
one or multiple computation apparatuses,
wherein the one or multiple computation apparatuses include a control program, one or multiple information programs, a management program, and a parameter set for each of the one or multiple information programs,
with respect to each of the one or multiple information programs, the parameter set is one or more parameters required for the information program,
the control program is a program that performs a scanning process that is a process for controlling the control object apparatus and is a process having real-time characteristics, at each control cycle defined for the control program,
with respect to each of the one or multiple information programs, the information program is a program that performs information processing defined for the information program,
the control program transmits, within the control cycle, a control instruction that is a signal representing a symbol associated with an activation object information program among the one or multiple information programs, and
the management program:
receives the control instruction;
identifies the activation object information program corresponding to the symbol represented by the received control instruction;
reads the parameter set for the activation object information program;
generates an activation signal associated with the read parameter set; and
outputs the generated activation signal to the activation object information program.

2. The control system according to claim 1,
wherein the plurality of computation apparatuses include a first computation apparatus and a second computation apparatus,
the first computation apparatus includes the control program, and
the second computation apparatus includes the one or multiple information programs, the management program, and the parameter set for each of the one or multiple information programs.

3. The control system according to claim 1, further comprising
an output apparatus coupled to at least one computation apparatus among the one or multiple computation apparatuses,
wherein the management program causes the output apparatus to execute output for notification about at least one of items including:
whether any of the information programs is in operation,
which information program is activated, and
whether the activated information program is in normal operation.

4. The control system according to claim 1,
wherein the management program:
accepts a processing result of the activated information program from the information program; and
notifies the processing result to the control program or to the information program in the computation apparatus that includes the control program.

5. A computation apparatus, comprising a storage apparatus, and a processor coupled thereto,
wherein the processor executes a management program,
a parameter set for each of one or multiple information programs is stored in the storage apparatus,
with respect to each of the one or multiple information programs, the parameter set is one or more parameters required to activate the information program,
with respect to each of the one or multiple information programs, the information program is a program that performs information processing defined for the information program,
the management program:
receives a control instruction from a control program, identifies the information program corresponding to a symbol represented by the received control instruction;
reads the parameter set for the identified information program;
generates an activation signal associated with the read parameter set; and
outputs the generated activation signal to the identified information program, and
the control program is a program that performs a scanning process that is a process for controlling a control object apparatus at each control cycle defined for the control program and is a process having real-time characteristics, within the control cycle, and is configured to transmit, within the control cycle, a control instruction that is a signal representing a symbol associated with an activation object information program among the one or multiple information programs.

6. A computer program that causes a computer to execute:
receiving a control instruction from a control program,
identifying an information program corresponding to a symbol represented by the received control instruction;
reading a parameter set for the identified information program;
generating an activation signal associated with the read parameter set; and
outputting the generated activation signal to the identified information program,
wherein the control program is a program that performs a scanning process that is a process for controlling a control object apparatus at each control cycle defined for the control program and is a process having real-time characteristics, within the control cycle, and is configured to transmit, within the control cycle, a control instruction that is a signal representing a symbol associated with an activation object information program among one or multiple information programs,
with respect to each of the one or multiple information programs, the parameter set is one or more parameters required to activate the information program, and
with respect to each of the one or multiple information programs, the information program is a program that performs information processing defined for the information program.
